(19) United States
(12) Patent Application Publication
(10) Pub. No.: US 2005/0072529 A1
(43) Pub. Date: Apr. 7, 2005

(54) Coating film transfer tool

(76) Inventors: Akira Yonezawa, Osaka-shi (JP); Kazuya Watanabe, Osaka-shi (JP); Masahiko Ono, Osaka-shi (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(21) Appl. No.: 10/681,413

(22) Filed: Oct. 7, 2003

(51) Int. Cl. B44C 1/00

(52) U.S. Cl. 156/540; 156/577

(57) ABSTRACT

A coating film transfer tool comprises a supply reel that delivers a transfer tape formed by coating a base tape with a coating film, a transfer head that presses the transfer tape against a receiving surface to transfer the coating film thereto, a take-up reel for taking up the base tape, and a belt-type driving mechanism cooperatively connecting the supply reel with the take-up reel. A belt guide for guiding the belt is disposed between the supply reel and the take-up reel. This transfer tool reduces backlash of the supply reel and more reliably transfers coating film to a desired position on a receiving surface.

### FIELD OF THE INVENTION

This invention relates to a coating film transfer tool for transferring by pressure a covering film, an adhesive film for adhesive bonding, or a decorative coating film, to a receiving surface. The invention relates more particularly to a coating film transfer tool provided with a belt-type driving mechanism for cooperatively connecting a supply reel with a take-up reel.

### BACKGROUND OF THE INVENTION

In FIG. 2, which illustrates the construction of a conventional coating film transfer tool 100, a case 111 is provided with two support shafts 113 and 114, a transfer head 109 projecting outside the case 111, a supply reel 103 rotatably mounted on the support shaft 113, a take-up reel 104 rotatably mounted on the support shaft 114, and a transfer tape 106, formed by coating a surface of a base tape 108 with a coating film 107. The case 111 is closed by a cover, not shown.

The transfer tape 106 is wound on the supply reel 103. The transfer head 109 has a tip 110, which presses the transfer tape 106, pulled from the supply reel 103, against a receiving surface to transfer the coating film 107 from the base tape 108 onto the receiving surface. The base tape 108 is wound onto the take-up reel 104. An endless rubber belt 105 extends between the supply reel 103 and the take-up reel 104 to connect the supply reel 103 with the take-up reel 104 for simultaneous rotation.

The reels 103 and 104 rotate at rates such that the rate of movement of the base tape onto the take-up reel 104 is not less than the rate of feed of tape from the supply reel 103. If it were not for the fact that the two reels are connected by a length of tape extending around the transfer head, the peripheral speed of the tape on the take-up reel 104 would be slightly greater than the peripheral speed of the tape on the supply reel. In this way, a tension is maintained in the tape to prevent slack.

If the tension in the transfer tape 106 exceeds a limit, the endless rubber belt 105 slips relative to the take-up reel 104. Consequently, excessive tension in the transfer tape 106 is avoided and the tape will not be broken. When the transfer head 109 of the conventional coating film transfer tool 100 presses the transfer tape 106 against a receiving surface to transfer the coating film onto the receiving surface, the supply reel 103 rotates as the transfer tape 106 is unwound from the supply reel 103, driving the rubber belt 105 toward the take-up reel 104. Consequently, one side of the rubber belt 105 slackens as indicated by broken lines in FIG. 2. At the same time, the other side of the rubber belt 105 is in tension, being pulled by the supply reel 103 to rotate the take-up reel 104.

When the transfer tool 100 is separated from the receiving surface, the rubber belt 105 tends to contract to its original length as a result of its own resilience. Consequently, the supply reel 103 is rotated in the reverse direction, and takes up a short length of the transfer tape 106. A part of the base tape 108, which had already passed the tip 110 of the transfer head 109, and is therefore not coated by the coating film 107, is pulled back toward the supply reel 103 through a backlash distance. Consequently, an uncoated part of the base tape 108 is on the approach side of the tip 110 of the transfer head. When the transfer tool 100 in this condition, the next time an attempt is made to transfer the coating film 107 to a receiving surface, an uncoated portion of the base tape 108 is pressed against the surface and the coating film 107 cannot be transferred until the tape is moved, by the backlash distance, past the transfer head tip 110. Therefore, in the case where the transfer tool is provided with a transfer tape having a covering film, it is difficult to use the transfer tool to cover a character to be erased.

It is an object of the invention to provide a belt-type coating film transfer tool capable of more reliably transferring a coating film to a desired part of an object.

### SUMMARY OF THE INVENTION

The coating film transfer tool according to the invention comprises a supply reel having a transfer tape wound thereon, the transfer tape comprising a base tape coated with a coating film; a transfer head for pressing the transfer tape against a receiving surface to transfer the coating film thereto; a take-up reel for taking up used base tape; and a belt-type driving mechanism. The driving mechanism comprises an endless belt cooperatively connects the supply reel with the take-up reel. The base tape extends from the supply reel, and past the transfer head to the take-up reel. A guide for guiding the belt is disposed between the supply reel and the take-up reel. In the preferred embodiment, the guide member is a roller.

The belt guide, disposed between the supply reel and the take-up reel, prevents the slack side of the rubber belt, extending between the supply reel and the take-up reel, from sagging. Since the slack side of the rubber belt is prevented from sagging, the tensile force acting on the tight side of the rubber belt is lower than the corresponding tensile force in the case of a transfer tool not provided with a belt guide. Consequently, the reverse rotation of the supply reel, that takes place when the pressure applied by the transfer head to a receiving surface is released, is reduced, and the length of the uncoated portion of the base tape on the approach side of the tip of the transfer head is reduced.

### BRIEF DESCRIPTION OF THE DRAWINGS

FIG. 1 is a side elevation of a coating film transfer tool in a preferred embodiment of the invention; and

FIG. 2 is a side elevation of a conventional coating film transfer tool.

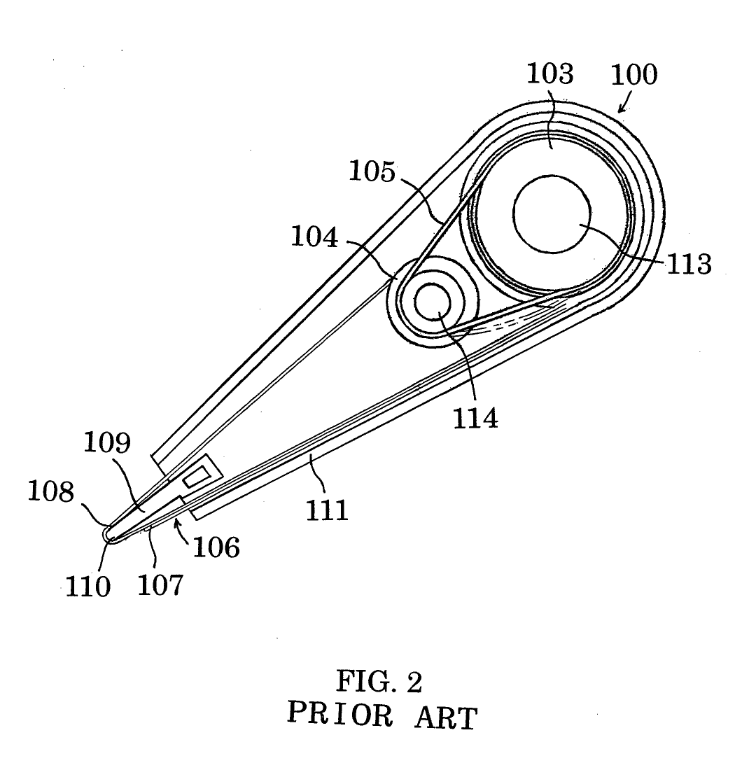

### DETAILED DESCRIPTION OF THE PREFERRED EMBODIMENTS

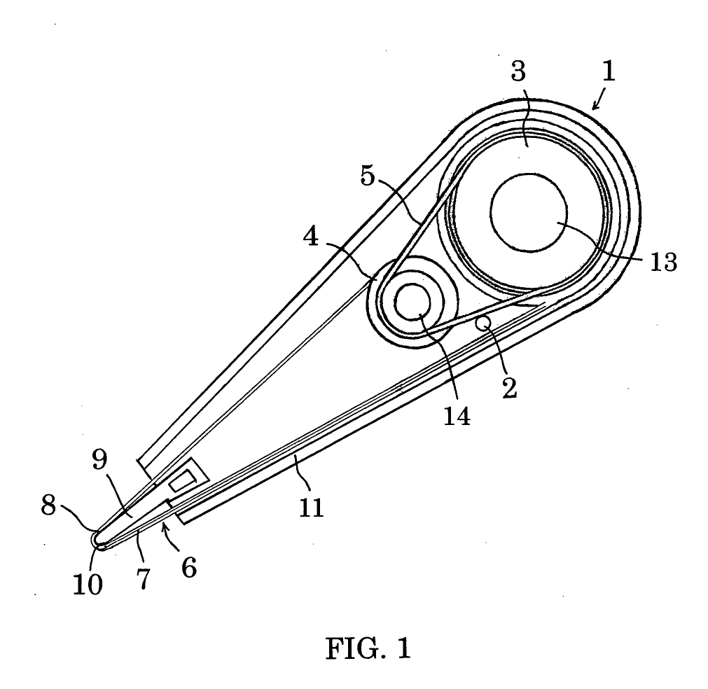

As shown in FIG. 1, the coating film transfer tool 1 in accordance with the invention has an elongated, tapered, case 11. The case is provided with two support shafts 13 and 14, a cover, not shown, and a transfer head 9 at the narrow end of the case. The transfer head has a pressing tip 10. A supply reel 3 is supported for rotation on shaft 13, and a take-up reel 4 is supported for rotation on shaft 14. An endless rubber belt 5 extends between the supply reel 3 and the take-up reel 4 to cooperatively connect the supply reel 3 with the take-up reel 4. A transfer tape 6, formed by coating one surface of a base tape 8 with a coating film 7, is wound on the supply reel 3. In operation of the transfer tool, the tape is unwound from the supply reel and pressed against a receiving surface, by the tip 10 of the transfer head 9, to transfer part of the coating film 7 to the receiving surface. The part of the base tape 8 from which the coating film 7 has been transferred to the receiving surface is wound onto the take-up reel 4. A guide member 2, for guiding the rubber belt 5, is disposed on the outer side of the rubber belt 5 to prevent the portion of the belt between the supply reel 3 and the take-up reel 4 from sagging outwardly.

Since the surface of the guide member 2 is in contact with the outer surface of the rubber belt 5, the guide member 2 preferably has a circular cross-section, and is preferably a roller. The guide member may be in the form of a circular cylinder, but is preferably, an hourglass-shaped roller. The position of the guide member 2 is selected so that the rubber belt 5 can be effectively prevented from slackening, and so that the guide roller 2 does not exert high resistance against the running rubber belt 5.

Although it is desirable to form the case 11 of the coating film transfer tool 1 from a transparent or semitransparent resin to enable visual observation of the transfer tape 6 inside the case, the case 11 may be formed of any suitable material such as an opaque resin, and a part of the case may even be formed of paper. The guide member 2 may be formed integrally with the case 11 or may be a discrete member. The guide member 2 may project from the case 11 or from the cover. The guide member 2 may project from the case 11, and its free end may be supported on the cover, and vice versa. The guide member may be formed of the same material as the case or the cover, or may be formed of a material different from the materials of the case and the cover. The guide member may be formed of a metal or a lubricative resin.

The following table compares the return movement of the base tape of the transfer tool having a guide member in accordance with the invention with the return movement of the tape in a conventional coating film transfer tool not provided with any guide member.

TABLE

| | Reverse turn of the | |
|---|---|---|
| Guide member | supply reel | Return movement |
| With guide member | Slight | 0.5 mm |
| (present invention) | | |
| Without guide member | Substantial | 3.0 mm |
| (Conventional) | | |

Twenty covering tape transfer tools without guide members, available from Fujicopian Co., Ltd., were used for tests. Guide members were added to ten of the twenty transfer tools. Covering films in the twenty test transfer tools were transferred to receiving surfaces. Then, the lengths of the parts of the base tape between the pressing tips of the transfer heads and the edges of the covering film on the approach side were measured. Each of the values for return movement shown in the Table is the mean of ten measured return movements.

The coating film transfer tool of the invention is able to transfer a coating film to a desired position onto a receiving surface immediately, because the end of portion of the transfer tape coated with a coating film is always near the tip of the transfer head every time the coating film transfer tool is used.

1. A coating film transfer tool comprising:
a supply reel having a transfer tape wound thereon, the transfer tape comprising a base tape coated with a coating film;
a transfer head for pressing the transfer tape against a receiving surface to transfer the coating film thereto;
a take-up reel for taking up used base tape; and
a belt-type driving mechanism, said driving mechanism comprising an endless belt cooperatively connecting the supply reel with the take-up reel;
wherein the base tape extends from the supply reel, and past the transfer head to the take-up reel; and
wherein a belt guide for guiding said belt is disposed between the supply reel and the take-up reel.

2. The coating film transfer tool according to claim 1, wherein the guide member is a roller.
